(19) United States
(12) Patent Application Publication
(10) Pub. No.: US 2025/0003686 A1
(43) Pub. Date: Jan. 2, 2025

(54) MEASURING SYSTEM FOR DETERMINING TEMPERATURE

(71) Applicant: EBNER Industrieofenbau GmbH, Leonding (AT)

(72) Inventors: Robert EBNER, Leonding (AT); Lukas FRUEHWIRT, St. Florian (AT); Marco BLIEWEIS, Linz (AT); Roland LUKATSCH, Hartkirchen (AT); Michael KLOSTERMANN, Peuerbach (AT)

(73) Assignee: EBNER Industrieofenbau GmbH, Leonding (AT)

(21) Appl. No.: 18/698,910

(22) PCT Filed: Oct. 5, 2022
(86) PCT No.: PCT/AT2022/060349

§ 371 Date: Apr. 5, 2024

(30) Foreign Application Priority Data
Oct. 8, 2021 (AT) A50807/2021

(51) Int. Cl. F27D 21/00; F27B 9/24; F27B 9/40; G01K 1/143; G01K 13/06

(52) U.S. Cl. CPC F27D 21/0014; F27B 9/24; F27B 9/40; G01K 1/143; G01K 13/06

(57) ABSTRACT

A measuring system for determining the temperature of a heat treatment material in a continuous furnace, includes a support, a data processing and/or data storage device and at least one temperature sensor, at least one receptacle for a sample of the heat treatment material being formed on the support, and the support being at least partially formed by a frame system.

The invention relates to a measuring system for determining the temperature of a heat treatment material in a continuous furnace, in particular in a floating belt system, comprising a support means, a data processing and/or data storage device and at least one temperature sensor, at least one receptacle for a sample of the heat treatment material being formed on the support means.

The invention also relates to a continuous furnace, in particular a floating belt system, comprising a conveying device for conveying a heat treatment material through the continuous furnace and a measuring system for determining the temperature of the heat treatment material in the continuous furnace.

In addition, the invention relates to a method for determining the temperature of a heat treatment material in a continuous furnace, in particular in a floating belt system, wherein temperature data are measured with at least one temperature sensor, for which purpose the temperature sensor is arranged on a sample of the heat treatment material which is placed on the heat treatment material and remains on the heat treatment material during the heat treatment, and transfer of the temperature data to a data processing and/or data storage device.

Continuous furnaces are often used for the heat treatment of metal belts, for example made of aluminum, a non-ferrous metal such as copper, or steel. The belt-shaped heat treatment material passes continuously through the continuous furnace, in particular as an endless belt. As this heat treatment method is known, reference is made to the relevant state of the art.

Naturally, the temperature and temperature distribution in the heat treatment material during heat treatment have a decisive influence on the properties of the finished heat treatment material. It is therefore desirable to know the temperature and distribution in the material during heat treatment.

Basically, there are several methods for temperature measurement in a continuous furnace, i.e. measurement of the furnace atmosphere (air temperature in the furnace) according to AMS 2750, measurement of the material temperature during the heating process, measurement of the material temperature during the quenching process (air and/or water cooling) and optical process monitoring of the annealing and quenching process.

DE 195 25 379 A1 describes a device for recording the operating parameters of a heat treatment process on workpieces in a tunnel furnace with a tunnel furnace car. A receiving antenna, a transmitting device that may be attached to a tunnel furnace car, which converts the operating parameters received from the individual measuring devices and transmits them in the form of electromagnetic signals, and a receiving antenna, which forwards the received signals to a data processing and storage device, are provided in the furnace.

KR 2015-0019379 A describes a device and a method for measuring the temperature of a heat treatment material in order to be able to measure the temperature of the heat treatment material inside, above and below. The device for measuring the temperature comprises support units, thermocouples and a data logger. A plurality of internal temperature measurement openings is provided in the heat treatment material. First and second support units are placed on the upper surface of the heat treatment material. The second support unit extends downwards. The thermocouples are positioned at the internal temperature measurement openings, the first support unit and the second support unit to measure the temperature inside and at the top and bottom of the heat treatment material. The data logger is placed on top of the heat treatment material and stores information about the temperature measured by the thermocouples through a connection to the thermocouples.

It is known from JP 2005-281811 A that a sample steel sheet connected to a measuring device is attached to a steel sheet without stopping the conveying path in order to measure the temperature profile of the steel sheet conveyed to a heat treatment furnace.

JP 2005-274297 A describes a steel sample plate which may be attached to and removed from the steel plate conveyed to the heat treatment furnace, and a measuring device which is attached to the steel sample and measures the temperature profile of the steel sample. The measuring device is provided with a heat-insulating housing to keep the temperature below the heat resistance temperature of the measuring device.

The present invention is based on the object of creating an improved measuring system for detecting the temperature of a heat treatment material during heat treatment in a continuous furnace.

The object of the invention is solved with the measuring system mentioned at the beginning, in which the support means is at least partly formed by a frame system.

Further, the object of the invention is solved by the continuous furnace mentioned at the beginning, which is provided with the measuring device according to the invention.

In addition, the object of the invention is solved by the method mentioned at the beginning, according to which it is provided that a measuring system and/or a continuous furnace according to the invention is used for measuring the temperature of a belt-shaped heat treatment material.

The advantage of the frame system is that the support means has a relatively low weight, which may also be distributed over a relatively large surface area of the heat treatment material. This makes it possible to provide a temperature measuring system that may be used safely and without damaging the material belt, even on materials that have a relatively low strength at the treatment temperature, such as thin aluminum belts. Due to the improved load transfer, heavier electronic components may also be better integrated into the measuring system. In addition, a measuring system may be made available that has a relatively low overall height, which means that it can also be used in continuous furnaces with a low passage height, in which thermocouple wires are often used today.

According to one embodiment variant of the invention, it may be provided that the frame system is configured as a tubular frame system. The tubular configuration may further reduce the weight of the support means, which may further improve the effects mentioned above.

According to a further embodiment variant of the invention, it may be provided that the frame system has frame system elements that can be telescopically slid into one another, at least in certain areas. On the one hand, this makes it easier to compensate for thermal expansion, and on the other hand, it also makes it easier to adapt the measuring system to different widths of the heat treatment material.

According to another embodiment variant of the invention, it may be provided that the frame system elements that can be telescopically slid into one another are arranged at the support regions of the measuring system on the heat treatment material, whereby different coefficients of thermal expansion between the materials of the heat treatment material and the support device can better be taken into account.

According to one embodiment variant of the invention, the support means may also be provided with swiveling frame system elements, which makes it easier to adjust the width of the measuring system to the width of the heat treatment material.

To further improve this effect, one embodiment variant may provide for the swiveling frame system elements to be arranged in the end areas of the frame system.

According to one embodiment variant of the invention, it may be provided that the support means is provided with at least one inclined plane. This inclined plane may be used to create a collision protection on the support means. The inclined plane serves to ensure that any obstacles that may occur due to the low passage height of a continuous furnace can slide on it, allowing the support means to give way against the pressure that builds up.

According to a further embodiment variant of the invention, it may also be provided that the data processing and/or data storage device is arranged on the support means. The measuring system may thus be more compact, making it easier to automatically arrange the measuring system on a heat treatment material without manual intervention.

It is advantageous if, according to one embodiment variant, the inclined plane is arranged in front of, in particular directly in front of, the data processing and/or data storage device. This means that it can be better protected against damage, thus preventing measuring errors or even failure of the measuring system.

According to a further embodiment variant of the invention, the support means may be provided with at least one attachment element for attaching the support means to the heat treatment material, whereby the compactness of the measuring system can be further improved, since fewer or no additional attachment elements are required for the arrangement of the measuring system on the heat treatment material.

A quick and easier to automate option for attaching the measuring system to the heat treatment material may be achieved if the at least one or at least one attachment element is configured as a clamping element. This makes it possible to attach the measuring system to any section of the heat treatment material without having to take any predetermined attachment points into account.

According to one embodiment variant, the clamping element may comprise an eccentric lever and clamping jaws and/or at least one inclined plane or inclined clamping plane, which may further improve the aforementioned effects.

For better protection of the data processing and/or data storage device against mechanical and thermal influences, it may be provided according to one embodiment variant of the invention that the data processing and/or data storage device is arranged below a protective element which is attached to the support means.

According to a further embodiment variant of the invention, it may be provided that a camera and optionally at least one light source is/are arranged on the support means. This enables optical detection of the furnace interior and, if necessary, subsequent (rapid) cooling of the heat treatment material. If necessary, the camera may also record a video sequence, which may be used to detect damage or wear to the system or to observe the behavior of the heat treatment material within the system. This also enables optical process monitoring with regard to the spray pattern of rapid water cooling (water quench).

According to an embodiment variant, it may be provided that the camera and/or the light source is/are arranged on the data processing and/or data storage device, in particular integrated therein, which not only makes it possible to achieve a compact unit, but also simplifies the transfer of data to the data processing and/or data storage device. In addition, no specific protective measures are required with regard to mechanical and/or thermal protection of the camera and/or the light source.

According to a further embodiment variant of the invention, it may be provided that a measuring tip of the sensor element is covered with a cover element for watertight sealing of the area of the arrangement of the measuring tip on the sample of the heat treatment material. The measuring system may thus be used more safely in a water cooling system, in particular a water quench, for the heat treatment material, as this may prevent a contact from breaking open, which can result in measuring errors.

This sealing may be achieved relatively easily with an embodiment variant of the invention in which the cover element is formed by a cover foil or a solder.

According to another embodiment variant of the invention, it may be provided that the measuring system comprises a device for time synchronization and/or position determination of the measuring system with a measuring system of the continuous furnace. This may improve the evaluation of all data supplied by the complete system during the heat treatment of a heat treatment material.

According to one embodiment of the continuous furnace, it may be provided that this has a device for automatical arrangement of the measuring system on the heat treatment material, which may improve the precision of the arrangement of the measuring system on the heat treatment material.

According to one embodiment variant, it may be provided that the device for automatical arrangement of the measuring system has an acceleration device for arranging the measuring system so that the measuring system may be arranged on the moving belt without interrupting production. According to a further embodiment variant, this device for the automatic arrangement of the measuring system may be arranged directly upstream of a furnace inlet.

Accordingly, it may be provided according to one embodiment variant of the method that the arrangement of the measuring system on the heat treatment material is carried out fully automatical with a device for automatical arrangement of the measuring system on the heat treatment material.

For the purpose of better understanding of the invention, this will be elucidated in more detail by means of the figures below.

These show respectively in a simplified schematic representation:

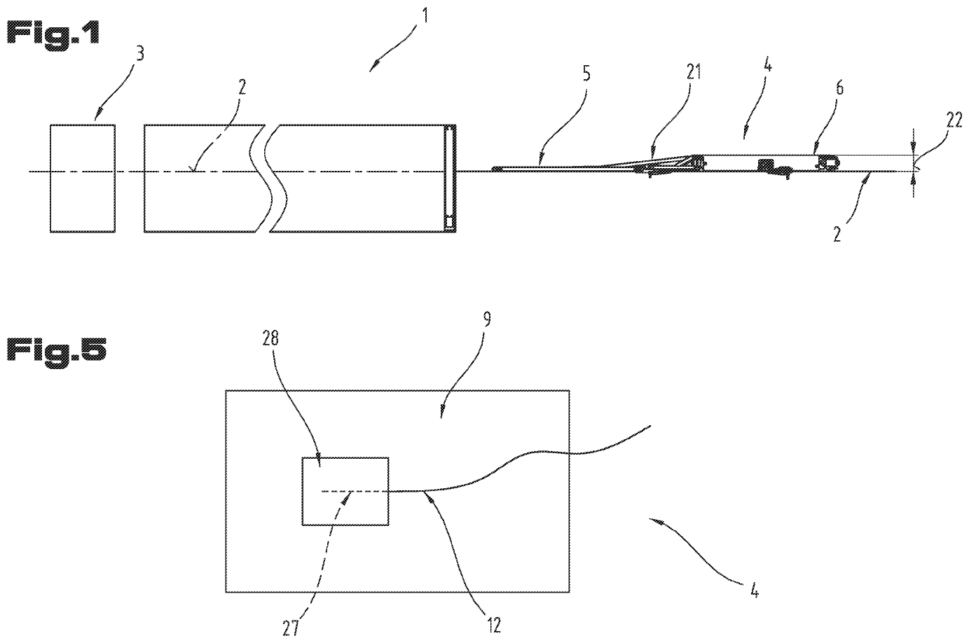

FIG. 1 a section of a heat treatment plant in the form of a continuous furnace;

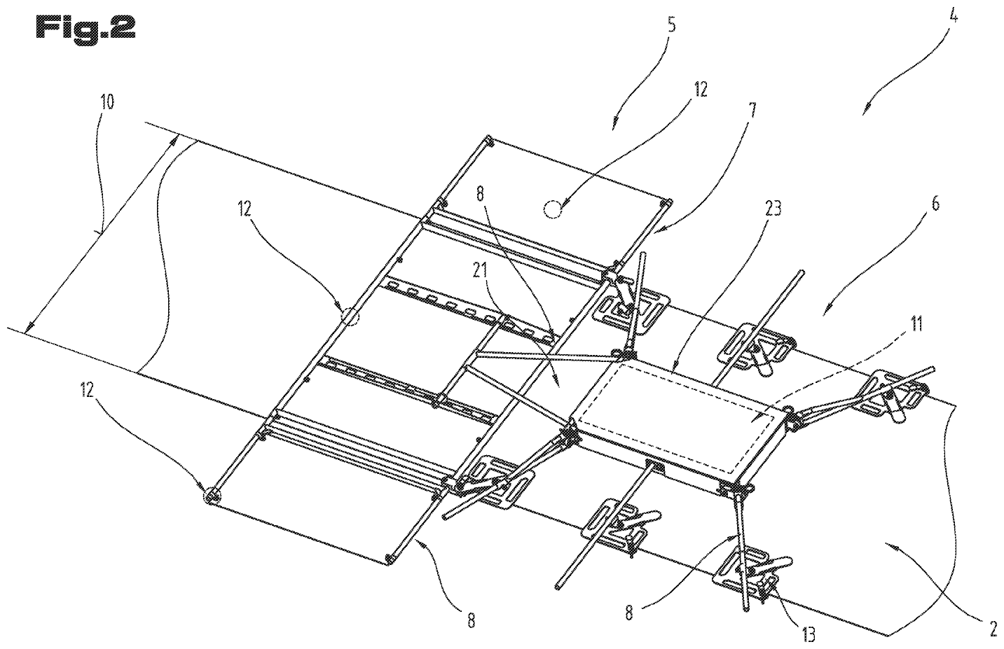

FIG. 2 an embodiment variant of a measuring system for determining the temperature of a belt-shaped heat treatment material in a continuous furnace in oblique view;

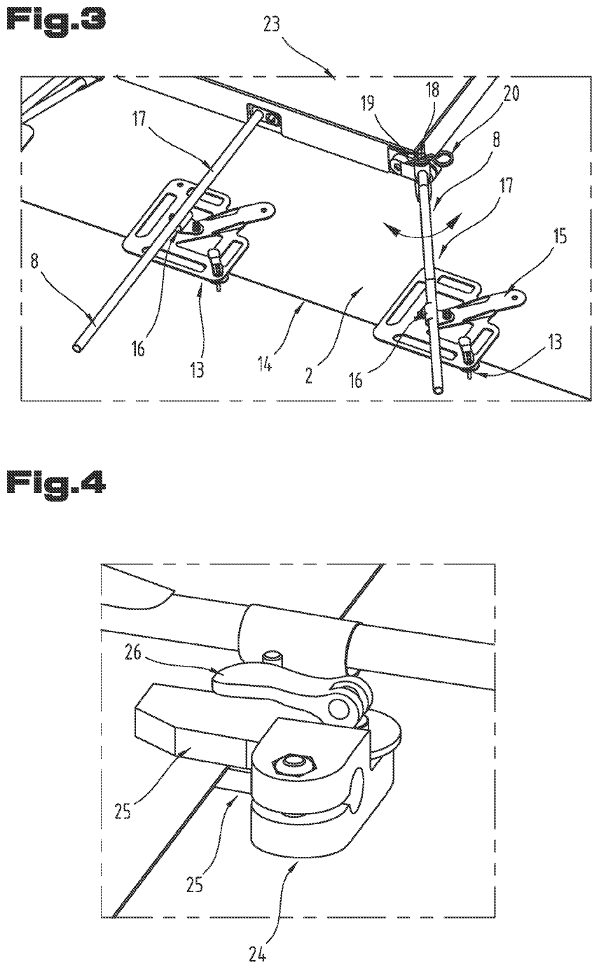

FIG. 3 a detail of the measuring system according to FIG. 2;

FIG. 4 an attachment element for manual attachment of the measuring system;

FIG. 5 a detail of a sensor element connection on a sample of a heat treatment material;

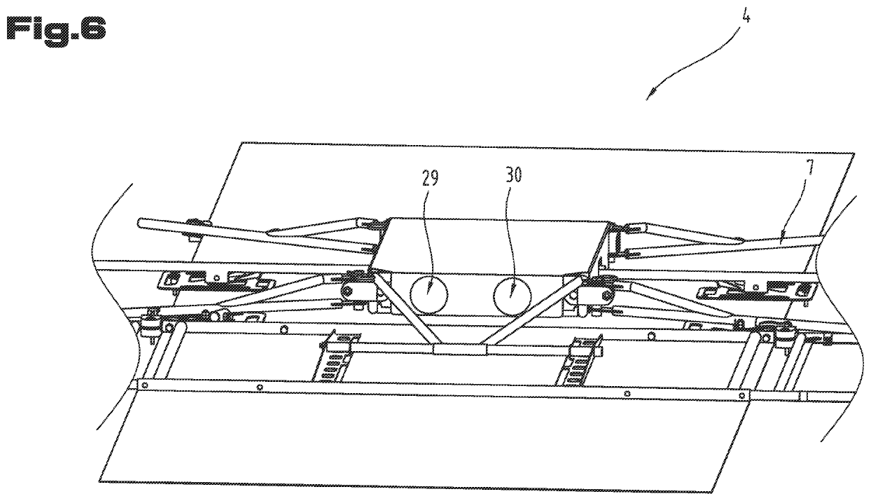

FIG. 6 an embodiment variant of the measuring system;

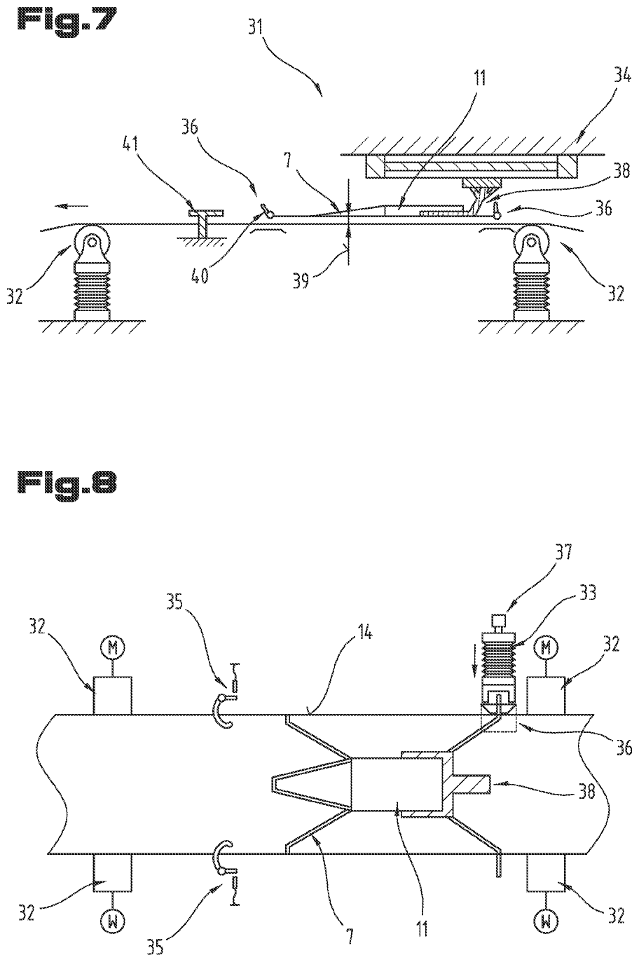

FIG. 7 a device for automatic arrangement of the measuring system on the heat treatment material in side view;

FIG. 8 a top view of the device for automatical arrangement of the measuring system on the heat treatment material as shown in FIG. 7;

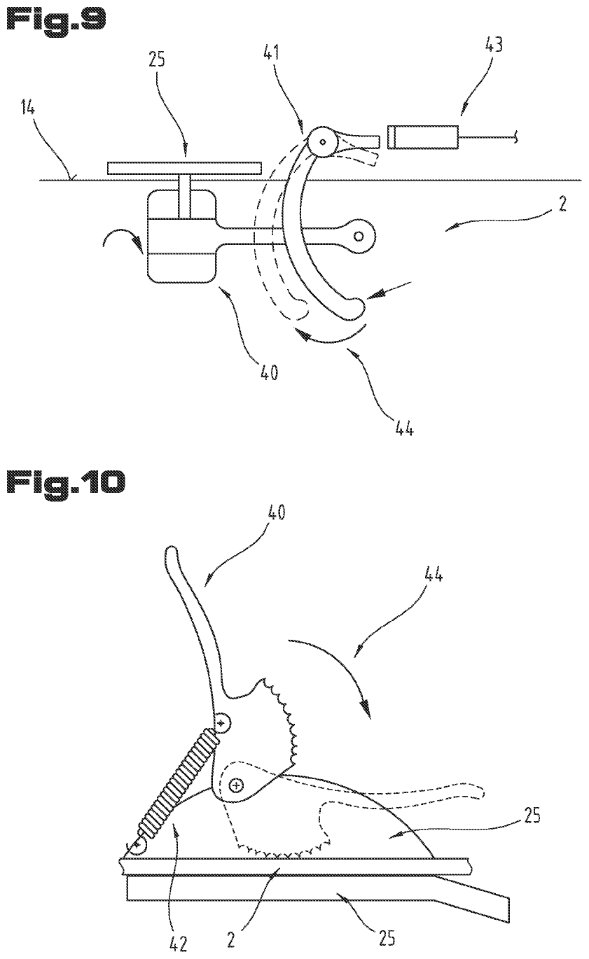

FIG. 9 a section of the embodiment variant of the device for automatic arrangement of the measuring system on the heat treatment material according to FIG. 7, top view;

FIG. 10 the section shown in FIG. 9 in side view;

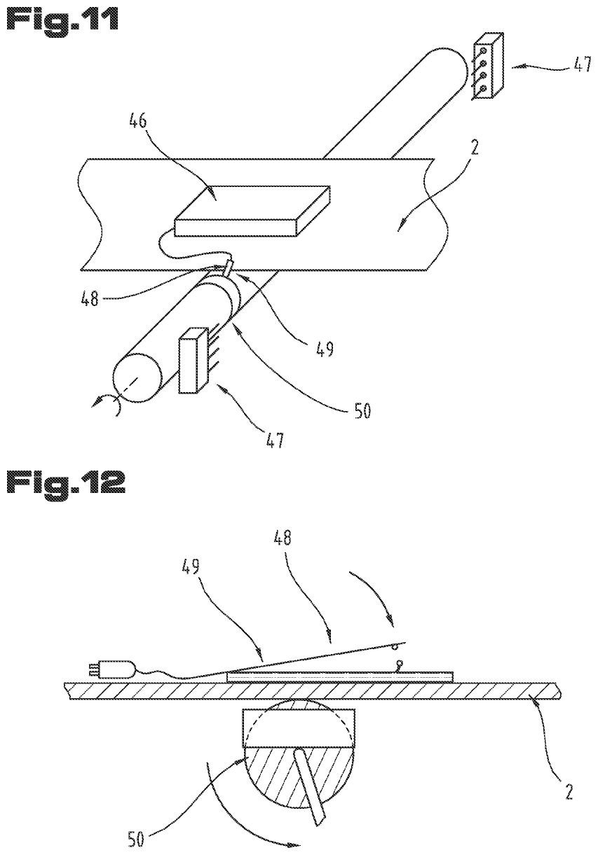

FIG. 11 a device for time synchronization of the measuring system with a measuring system of the continuous furnace;

FIG. 12 an embodiment variant of a device for time synchronization of the measuring system with a measuring system of the continuous furnace;

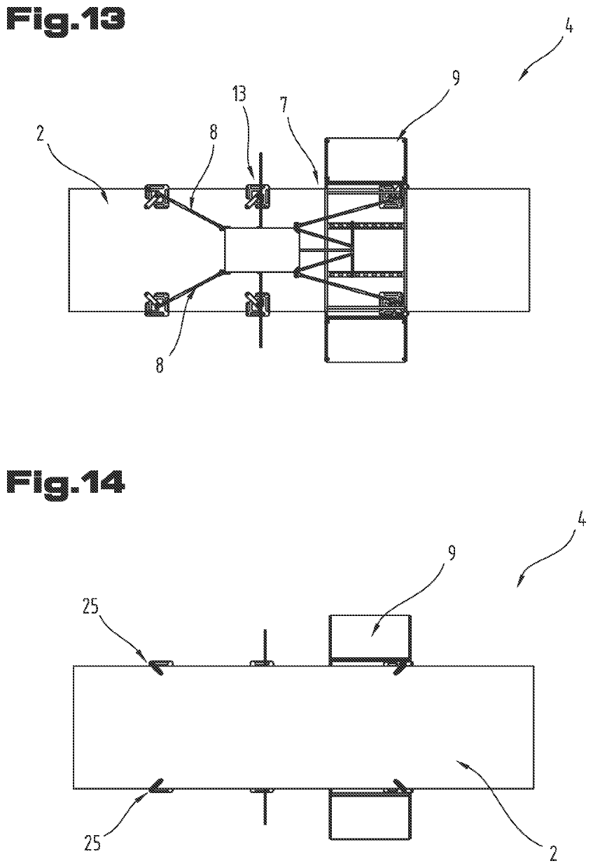

FIG. 13 a top view of a further embodiment variant of the measuring system arranged on a heat treatment material;

FIG. 14 the measuring system arranged on the heat treatment material according to FIG. 13 as seen from below.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

If the following terms are used in the following, they are to be understood in accordance with the following explanations.

Thermocouple: a sensor for detecting temperatures at specific positions.

Thermocouple wire: a thermocouple with an insulating structure made of glass fiber material.

Sheathed thermocouple: a thermocouple with an insulating structure made of magnesium peroxide and steel sheathing.

Data logger: a measuring device for recording temperatures over time.

FIG. 1 shows a detail of a heat treatment plant. The heat treatment system comprises a heat treatment furnace. In the embodiment variant of the heat treatment plant shown, the heat treatment furnace is a continuous furnace 1. The continuous furnace 1 is preferably configured as a floating belt furnace, i.e. the heat treatment system is preferably a floating belt system. However, the continuous furnace 1 may also be configured differently, for example as a roller hearth furnace, etc.

In the heat treatment furnace, a heat treatment material 2 is subjected to heat treatment. Heat treatment is used to adjust the mechanical properties, such as the hardness of the heat treatment material, etc., by solution annealing, recrystallization annealing, etc. In addition to the furnace itself, the heat treatment plant may also comprise a quenching device 3, such as a water quench, which also serves to adjust the desired mechanical properties of the heat treatment material 2. The quenching device 3 is arranged after the heat treatment furnace, for example immediately after the exit from the heat treatment furnace. It may also be integrated into the heat treatment furnace if appropriate structural measures are provided for this purpose. The quenching device 3 is preferably also configured as a continuous device. Since such heat treatment systems or the aforementioned components thereof are already sufficiently described in the prior art, reference is made to this prior art in order to avoid repetition of further details. As an example, reference is made to the patent applicant's heat treatment plants.

The heat treatment material 2 is configured in particular in the form of a belt, for example as an endless belt, and is conveyed as such through the heat treatment plant. To form the endless belt, the ends of different coils are joined together. This is also sufficiently described in the relevant state of the art. However, the heat treatment material 2 may also be configured differently, for example in the form of blanks or (thin) sheets.

The heat treatment material 2 is in particular a metal or a metal alloy, such as aluminum or steel or a non-ferrous metal or a non-ferrous metal alloy, etc.

In order to be able to follow the temperature or temperature distribution of the heat treatment material 2 during heat treatment, a measuring system 4 for measuring the temperature (hereinafter referred to as measuring system 4) is arranged on the heat treatment material 2 before it enters the heat treatment furnace. FIG. 2 shows a preferred embodiment variant of the measuring system 4.

In principle, the measuring system 4 may also be used to measure other parameters in addition to temperature measurement or alternatively, if the measuring system 4 is provided with a corresponding sensor element for this parameter, such as the proportion of moisture in the atmosphere in the heat treatment system, etc. In the preferred embodiment variant, the measuring system 4 is provided for temperature measurement, for which purpose the measuring system 4 has at least one temperature sensor.

In the preferred embodiment variant, the measuring system 4 is designed as a unit that may be prepared as such away from the heat treatment system and placed as a unit on the heat treatment material 2. In particular, the measuring system may have a modular structure consisting of interconnected modules and may, for example, comprise or consist of a measuring module 5 for measuring the temperature and a data module 6 for processing and/or storing the data collected in the measuring module.

The measuring module 5 or the measuring system 4 in general is provided with a support means 7. The support means 7 is designed as a frame system with frame elements 8. The frame elements 8 may form frames or receptacles that are closed on all sides or partly open (viewed in relation to the circumference). In the most simple configuration of the measuring system 4, there is a frame in which a sample 9 of the heat treatment material 2 is held or received. In the embodiment variant of the measuring system 4 shown in FIG. 2, there are three samples 9, one of which is arranged in the middle in relation to a width 10 of the heat treatment material 2, and one of which is arranged at each side. The specific arrangement or the specific number of samples 9 depends on the corresponding conditions, so that the temperature distribution in the heat treatment material 2 and in the heat treatment furnace can be determined as accurately as possible with the samples 9. This means that only one or two or more than three samples 9 may be arranged or provided.

The samples 9 may each be held in a separate frame or receptacle or in a common frame or receptacle consisting of the frame elements 8 of the support means 7.

The use of separate samples 9 from the heat treatment material 2 instead of direct measurement of the belt shaped heat treatment material 2 has the advantage that the measuring system 4 can be prepared more easily and placed on the heat treatment material 2 as a complete unit. The heat treatment material 2 is then moved through the continuous furnace 1 with the measuring system 4 or treated in the heat treatment furnace, so that the at least one sample 9, which also consists of the heat treatment material 2, is subjected to the same conditions as the heat treatment material 2 itself.

With the measuring system, a saving in production time may be achieved due to the pre-fitting of the samples 4 or the measuring system 2. In addition, a saving in production material may be achieved, as only test pieces are used for measurement instead of the entire belt, and no damage is caused by the direct attachment of measuring sensors to the heat treatment material 2 itself, particularly in belt form.

As mentioned, the measuring system 4 also comprises at least one data module 6. In principle, this may be arranged externally, i.e. outside the heat treatment furnace. Preferably, however, the data module 6 is also arranged on the heat treatment material 2 and undergoes the heat treatment process, wherein in the particularly preferred embodiment the data module 6 is connected to or arranged on the support means 7, in particular is also held by frame elements 8. These frame elements 8 do not necessarily have to form a frame, as may be seen in FIG. 2, although this is possible.

The data module 6 comprises at least one data processing and/or data storage device 11, in particular a so-called data logger, which is preferably equipped to be heat-resistant, for example having corresponding heat protection elements. By arranging the data processing and/or data storage device 11 on the support means 7, a better weight distribution of the data processing and/or data storage device 11 on the heat treatment material 2 may be achieved and thus damages, e.g. by forming a corrugation, may be avoided.

The frame elements 8 may each be separately connected to the data processing and/or data storage device 11 without being directly connected to each other. In the embodiment variant shown, six frame elements 8 are used to achieve a better load transfer of the weight of the data processing and/or data storage device 11 on the heat treatment material 2. However, this number is not to be construed as restrictive. It is also possible that fewer or more frame elements 8 are present for this purpose.

To connect the frame elements 8 to the data processing and/or data storage device 11, corresponding connecting elements known to the skilled person may be provided.

The frame elements 8 of the data module 6 may be arranged perpendicular to it or at an angle other than 90°, wherein the frame elements 8 may be arranged at an angle, particularly in the corner areas.

The measuring module 5 and the preferably existing data module 6 may be arranged at a distance from the surface of the heat treatment material 2 or preferably placed directly on it, which can reduce the required height.

At least one temperature sensor 12 is provided to measure the temperature. Preferably, several temperature sensors 12 are used in order to obtain a better or more accurate picture of the temperature distribution in the heat treatment furnace. The exact number of temperature sensors 12 and their positioning may depend on the conditions on site and does not necessarily have to be as shown in FIG. 2.

The temperature sensors 12 are arranged on and connected to the sample(s) 9. At least one temperature sensor 12 may also be provided to measure the furnace atmosphere (air temperature). The sensor may be arranged accordingly on the measuring system 4. In addition, the temperature sensors 12 are connected to the data processing and/or data storage device 11 for data transmission. In the preferred embodiment variant of the measuring system, thermocouples, in particular sheathed thermocouples, are used as temperature sensors 12. However, other types of temperature sensors 12 may also be used.

The frame elements 8 are preferably made of a metal or a metal alloy. Furthermore, the frame elements 8 of the support means 7 may be designed as solid profile elements. According to one embodiment variant of the measuring system 4, however, the frame elements 8 are configured as tubular frame elements, so that the frame system is configured as a tubular frame system.

The frame elements 8 may have a round, square or generally polygonal cross-section. They may also be configured as open profiles with a C-shaped cross-section, etc.

To increase the support and thus improve load distribution, the support device 7 may have support elements 13 according to one embodiment variant, which may preferably be plate-shaped. The support elements 13 are shown more clearly in FIG. 3. Preferably, they are disposed with contact on the edge area of the heat treatment material 2 along a material edge 14.

The measuring system according to claim 2 is characterized in that the frame system has frame system elements which can be telescopically slid into one another at least in certain areas.

The support elements 13 may have a attachment lug 15, which preferably protrudes from the plane of the support element 13. The attachment lug 15 may also be used as a handling element to make it easier to place the support elements 13 on the heat treatment material 2 and lift them off again.

Preferably, one support element 13 is provided for each frame element 8 of the data module 6 and is connected to the respective frame element 8. However, a plurality of frame elements 8 may also be connected to a common support element 13. For example, there may only be one support element 13 per material edge 14.

The connection between a frame element 8 and its associated support element 13 may be fixed, i.e. rigid, for example by welding. According to one embodiment variant, however, the support element 13 may have a receptacle element 16, which is shaped according to the cross-section of the frame element 8 and in which the frame element 8 is received in a longitudinally displaceable manner to compensate for changes in length and/or for better adaptability of the measuring system 4 to heat treatment materials 2 with different widths 10, as may be seen in FIG. 3.

Instead of or in addition to this, frame elements 8 of the data module 6 may have frame system elements 17 that can be telescopically slid into one another for the same purpose according to a further embodiment variant of the measuring system 4, as indicated by stroke-dotted lines on the left frame element 8 in FIG. 3. The property that the frame system elements can be telescopically slid into one another may be configured in the course of the frame element 8 and in particular in the region of a support area of the support means 7, i.e. the support element 13.

Also for better adaptability of the measuring system 4 to heat treatment materials 2 with different widths 10 (see FIG. 2), it may be provided that the support means 7 has swiveling frame system elements 17. These are preferably arranged in the corner areas of the data processing and/or data storage device 11, as may be seen in FIGS. 2 and 3. The swiveling is indicated in FIG. 3 by a round double arrow. The receptacle elements 16 may be arranged on the support element 13 to compensate for the length. A swivel axis 18 may be provided in the area of the data processing and/or data storage device 11 for swiveling. This may be secured against slipping off a swivel axis mount 19, for example with a securing element such as a cotter pin 20. As can be seen from FIG. 13, the cotter pin 20 may also be dispensed with. However, the swiveling of the frame system element 17 may also be produced differently than shown in FIG. 3.

In the preferred embodiment variant of the swivable frame elements, the swiveling is produced in the end areas of the frame system elements 17. However, the swiveling may also be produced at another point along the length of the frame element 8.

According to a further embodiment variant of the measuring system, which may be seen in particular in FIGS. 1 and 2, the support means 7 may have at least one inclined plane 21. This may be formed, for example, by two frame elements 8, which are connected on the one hand to the measuring module 5 or a sample 4, and on the other hand, according to a further embodiment variant, to the data processing and/or data storage device 11, so that this inclined plane 21 is thus formed directly in front of the data processing and/or data storage device 11.

However, the data processing and/or data storage device 11 may also be spaced apart from the inclined plane 21, for example by arranging further frame elements 8 between the inclined plane 21 and the data processing and/or data storage device 11.

The inclined plane 21 is configured to rise in the direction of the data processing and/or data storage device 11, since the data processing and/or data storage device 11 generally has a greater height 22 compared to the samples 4. The inclined plane 21 may provide the measuring system 4 with greater safety by safely intercepting impending collisions without causing damage to the plant or the system itself. The inclined plane 21 may therefore be used to slide an obstacle along it, wherein the measuring system 4 together with the heat treatment material 2 or, if a gap is formed between the data processing and/or data storage device 11 and the heat treatment material 2, only the measuring system 4 may be displaced downwards and may thus give way.

The inclined plane 10 may, for example, be trapezoidal in plan view, as may be seen in FIG. 2. However, it may also have a different shape, for example triangular or square or rectangular, etc.

As may be seen from FIG. 2, the data module 6 may be connected to the measuring module 5 via the two frame elements 8 forming the inclined plane, which are attached to a further frame element 8 of the measuring module 5. However, this connection may also be established in a different way.

The data processing and/or data storage device 11 may be directly connected to the support means 7. According to one embodiment variant of the measuring system, however, it may also be provided that the data processing and/or data storage device 11 is arranged below a protective element 23, which is attached to the support means 7. The protective element 23 may be a simple cover, which may extend into the side areas of the data processing and/or data storage device 11. However, the protective element 23 may also be part of a housing in which the data processing and/or data storage device 11 is arranged. The protective device 23 makes it possible for the measuring system 4 to also record data in the quenching device 3 (see FIG. 1), so that the effectiveness or uniformity of the cooling can also be observed and, if necessary, readjusted by measuring the temperature of the heat treatment material 2 during the quenching process (e.g. air or water cooling) using this data.

The measuring system 4 may simply be placed on the heat treatment material 2 and transported through the heat treatment furnace. During heat treatment, however, a displacement of the measuring system 4 may occur both due to convection or due to a possible collision with the plant. For this reason, the measuring system is preferably attached to the heat treatment material 2, in particular with regard to the heat treatment material 2 in a non-destructive manner and detachable from it.

In the preferred embodiment variant of the measuring system 4, this therefore is provided with at least one attachment element, wherein preferably a plurality of attachment elements is arranged, for example one attachment element per support element. Preferably, all attachment elements of the measuring system are configured in the same way for attaching it to the heat treatment material 2.

The attachment element may, for example, have two screw jaws that are screwed together with a screw so that the heat treatment material 2 is clamped between them. According to a further embodiment variant of the measuring system 3, however, the attachment element may be a clamping element 24, as shown as an example in FIG. 4. This clamping element 24 is also particularly suited for attaching the frame element system of the measuring module 5 to the heat treatment material 2.

The clamping element 24 may be provided with two clamping jaws 25 and an eccentric lever 26 for quick and easy actuation. For attaching, the heat treatment material 2 is inserted between the clamping jaws 25 and then closing is produced by moving the eccentric lever 26 so that the heat treatment material 2 is clamped. FIG. 4 shows the closed position of the clamping element 25.

As may be seen in FIG. 3, one of the clamping jaws 25, in particular the upper one, may be formed by the support element 16. According to a further embodiment variant, the clamping jaw 25 may be wedge-shaped (with at least one inclined plane). The advantage here is that the clamping force can be increased due to the mass inertia.

FIG. 5 shows a detail of a further embodiment variant of the measuring system 4. In particular, this figure shows a sample 9 with a temperature sensor 12 in the area of the connection with the sample 9. The temperature sensor 12 may, for example, be connected to the sample 9 in a force locking and/or material-formed manner. In order to better prevent this connection from breaking in the area of the quenching device 3 (see FIG. 1), in this embodiment variant a measuring tip 27 of the temperature sensor 12 or generally of the sensor element is covered with a cover element 28 for watertight sealing of this area, so that the measuring point is sealed watertight.

In principle, sealing may be carried out in any suitable way. In the preferred embodiment variant, however, the sealing is also produced in a material-formed manner by welding or soldering a metallic cover foil onto the sample 9 as a cover element 28 or by introducing the measuring tip 27 in an indentation in the sample 9 and filling this indentation with a metallic solder.

According to a further embodiment variant of the measuring system 4, it may be provided that a camera 29 or generally an image generation and/or image recording device and possibly at least one light source 30 is/are arranged on the support means 7. In the preferred embodiment variant, these are arranged on the data processing and/or data storage device 11, in particular integrated into it, as may be seen in FIG. 6.

This embodiment variant makes it possible to optically detect the interior of the heat treatment furnace and, if necessary, the quenching device 3. The camera 29 may record still images or a video sequence. This data may be used to monitor damage or wear to the system or the belt behavior within the plant. The optical process monitoring may therefore be used, for example, to check the belt behavior in the furnace interior, the spray pattern of the quenching device 3 or to inspect the furnace interior during heat treatment.

According to a further embodiment variant of the invention, it may be provided that this comprises a device 31 for automatical arrangement of the measuring system 4 on the heat treatment material 2. A possible configuration of this device 31 is shown in FIGS. 7 to 10.

The device 31 comprises or consists of positioning rollers 32, an adjustment device 33 for adjusting the belt width, an acceleration device 34, an engaging device 35 for engaging the clamping device and a fixing device for fixing the system to the heat treatment material 2. The fixing device may be configured as clamping elements 24 as described above.

A clamping device may be used to attach the system, which allows it to be attached without stopping the heat treatment material 2, i.e. on the running heat treatment material 2.

It should be mentioned at this point that it is also possible within the scope of the invention to stop the heat treatment material 2 in order to arrange the measuring system 2 on it.

The advantages of an automatic arrangement of the measuring system 4 on the heat treatment material 2 include a realistic recording of measurement data of the process and avoidance of errors due to manual fixing (the latter is also possible within the scope of the invention).

In the preferred embodiment variant, the device 31 for automatical arrangement of the measuring system 4 on the heat treatment material 2 is located directly in front of the inlet of the heat treatment furnace, in particular the continuous furnace 1.

The automatic arrangement of the measuring system 4 is achieved by the sequence of the following steps:
raising the positioning rollers 32
feeding clamping clasps 36 on the belt edge
accelerating the support means 7 with the data processing and/or data storage device 11
engaging the clamping device by clamping stop
build-up of clamping force due to mass inertia
uncoupling the centering arm

The device 31 for automatical arrangement of the measuring system 4 on the heat treatment material 2 may comprise two or four positioning rollers 32, wherein in the case of four positioning rollers 32, two may be provided for each material edge 14, which are arranged at a distance from one another. More or less than two or four positioning rollers 32 may also be used.

The positioning rollers 32 stabilize the heat treatment material 2 in the clamping area. In addition, the distance between the heat treatment material 2 and the measuring system 4 may be reduced in order to simplify its installation. The lifting of the positioning rollers 32 may be carried out mechanically, hydraulically or pneumatically. In particular, an electric motor may be provided for this purpose.

With the adjustment device 33 or the adjustment devices 33 for adjusting the belt width, the clamping clasps 36 may be displaced relative to the material edges 14 so that the support means 7 can be engaged. The clamping clasps 36 may be displaced mechanically, hydraulically or pneumatically. In particular, an electric motor 37 may be provided for this purpose. The adjustment devices 33 may be fed at the corner areas.

The acceleration device 34 is used to accelerate the measuring system 4 to the speed of the heat treatment material 2 in order to enable easier attachment. The acceleration device 34 itself may correspond to the state of the art for such acceleration devices. For force transmission, a centering arm 38 may be arranged on the acceleration device 34, with which the measuring system 4 can be guided until it is fully attached on the heat treatment material 2. Once the measuring system 4 is fully attached to the heat treatment material 2, the centering arm 38 is uncoupled from the measuring system 4.

The centering arm 38 may, for example, have a U-shaped end area in which the area of the data processing and/or data storage device 11 of the measuring system 4 can be accommodated, as may be seen in FIGS. 7 and 8.

However, the measuring system 4 may also be coupled to the acceleration device 34 in a different way or in a different area of the support means 7, for example with finger-shaped or spike-like extensions that engage releasably in the frame system of the support means 7.

During the acceleration of the measuring system 4, a distance 39 is created between it and the heat treatment material 2, which is preferably relatively small.

With the engaging device 35 for engaging the clamping device, the clamping device can be engaged via a clamping stop. Reference is also made in particular to FIGS. 9 and 10. A lever 40 is deflected by a stop 41 (see FIG. 8). The lever 40 can be fixed in the respective end position via a (pretensioned) spring 42. The stop 41 is rotatably mounted so that optional built-in sensorics 43 can monitor the engagement process. It may be engaged by turning the lever 40 in the direction of the arrow 44.

The clamping itself may be carried out using the clamping jaws 25 described above.

Due to the mass inertia of the measuring system 4, a relative speed is created between the measuring system 4 and the heat treatment material 2. This causes the clamping lever to wedge, which increases the clamping force and builds up friction. Once the system has been fixed, the centering arm 38 is uncoupled from the measuring system 4.

The automatic lifting of the measuring system 4 after the heat transfer material 2 has passed the heat treatment furnace or heat treatment plant may be carried out in the reverse process, wherein the acceleration device 34 may be dispensed with.

According to a further embodiment variant of the invention, it may be provided that the measuring system 4 comprises a device 45 for time synchronization of the measuring system 4 with a measuring system of the continuous furnace 1 or the heat treatment plant. Please refer to FIGS. 11 and 12.

In the course of heat treatments, both the data records from the measuring system 4 and from the heat treatment system itself may be evaluated. As the data is recorded by different systems, synchronization is advantageous in order to be able to assign the individual data from the different measuring systems to specific points in time more precisely. Alternatively or additionally, this also makes it possible to determine the position of the measuring system 4 in the continuous furnace 1 more precisely.

To determine the entry position of the measuring system 4, a trigger signal may be triggered at the data processing and/or data storage device 11 and at least one other data processing and/or data storage device of the system, in particular at several data loggers.

The trigger signal at the central data storage device of the heat treatment plant may be triggered via a light grid or a light barrier 47 at the inlet of the heat treatment furnace.

The triggering of the trigger signal at the data processing and/or data storage device 11, in particular a data logger 46, of the measuring system 4 may be triggered via a heat-resistant switch 48, which is triggered when a certain position is passed. A flexible steel strip 49 made of ferromagnetic material may be attached to the measuring system 4, in particular the support means 7, for this purpose. The positive and negative poles of switch 48 are separated in the normal state. A stationary magnet 50 may be located in front of the input of the heat treatment furnace, which bends the steel strip 49 downwards and thus closes the contact.

The data logger 46 may also be formed by the data processing and/or data storage device 11.

The measuring system 4 enables executing a method for determining the temperature of a, in particular belt-shaped, heat treatment material 2 in a continuous furnace 1, in particular in a floating belt installation, temperature data being measured with at least one temperature sensor 12, for which purpose the temperature sensor 12 is arranged on a sample 9 of the heat treatment material 2 which is placed on the heat treatment material 2, and remains on the heat treatment material 2 during the heat treatment, and transferring the temperature data to a data processing and/or data storage device 11, wherein a measuring system 4 according to any one of embodiment variants described above is used for measuring the temperature of the heat treatment material 2 and/or the method is carried out in a continuous furnace 1 according to any one of embodiment variants described above.

Just for the sake of completeness, it should be noted that the measuring system 4 may be reused with new samples 9 for further measurements of the temperature of heat treatment materials 2, in particular belt-shaped heat treatment materials, during heat treatment in a heat treatment plant.

FIGS. 13 and 14 show a further and possibly independent embodiment variant of the measuring device 4, again using the same reference signs or component designations for the same parts as in previous FIGS. 1 and 12. In order to avoid unnecessary repetition, reference is made to the detailed description for the previous FIGS. 1 to 12.

The measuring system 4 is again shown arranged on the heat treatment material 2.

In principle, the measuring system 4 of this embodiment variant is similar to the embodiment variant of the measuring system 4 shown in FIG. 2. Again, the support means 7, which is at least partially formed by a frame system, comprises at least one sample 9 held by the support means 7. The support elements 13 are provided for arrangement on the heat treatment material 2. In contrast to the measuring system 4 according to FIG. 2, however, the support elements 13 are arranged further apart from each other on the heat treatment material 2, one support element 13 or two or more support elements 13 being arranged in the area of the sample(s) 9, in particular in the area of the front end faces of the sample(s) 9 (viewed in the direction of passage through the continuous furnace 1). However, they may also be offset further in the direction of the data storage device 11, i.e. between the front and rear end faces of the sample(s) 9.

The rear frame elements 8 of the support means 7 may also be longer so that the angle between these two frame elements 8 is smaller. As a result, the rear support elements 13 are also arranged further away from the data storage device 11.

The stability of the arrangement may be improved with this embodiment variant of the measuring system.

In general, the relative distance between the support elements 13 may therefore be different. The arrangement of the measuring system 4 on the heat treatment material 2 may be more compact (as shown in FIG. 2) or more expansive (as shown in FIG. 13). Although the specific embodiment variants of the measuring system 4 shown in FIGS. 2 and 13 are preferred embodiment variants, they are not intended to limit the invention.

The view in FIG. 14 shows the clamping of the measuring system 4 with the clamping jaws 25. As can be seen, only the foremost and rearmost support elements 13 are provided with clamping jaws 25 and the clamping jaws are arranged in opposite directions. This specific configuration of the clamping may generally be provided for all embodiment variants of the invention. However, other configurations of the clamping of the measuring system 4 on the heat treatment material 2 are also possible.

The exemplary embodiments show possible embodiment variants, wherein it should be noted at this point that combinations of the individual embodiment variants with one another are also possible. Furthermore, individual features of the invention may be independent inventions. For example, a measuring system or a system with a support means 7, on which at least one camera 29 and possibly at least one light source 30 are arranged, as well as the above-mentioned uses may form independent inventions. The arrangement of the camera 29 and possibly the light source may be provided directly on the support means 7 or on (in particular directly on) a data processing and/or data storage device 11, preferably a data logger, which is preferably provided in the measuring system.

Furthermore, the watertight sealing of the measuring tip 27 according to the previous embodiments may be an independent invention. Thus, the present invention may be a measuring system comprising at least one sensor element, wherein the sensor element has a measuring tip 27 which is arranged in a watertight manner with a heat treatment material 2, in particular a sample 9 of the heat treatment material 2, which is held in a support means 7, in particular covered with a cover element, preferably in the form of a cover foil or a solder.

Furthermore, a measuring system may represent an independent invention, wherein the measuring system comprises a device 45 described above for time synchronization of the measuring system with a measuring system of the continuous furnace 1 or a heat treatment plant. Preferably, this measuring system also is provided with a data processing and/or data storage device 11, preferably a data logger, which is held by a support means 7.

A measuring system or a heat treatment system comprising a device 45 for automatic arrangement of the measuring system on the heat treatment material according to the previous embodiments may also be an independent invention.

In all these independent inventions, the support means 7 does not necessarily have to be configured as a frame system, but may also be configured differently. Furthermore, the measuring system 4 of the independent inventions does not necessarily have to comprise a data processing and/or data storage device 11, although this is preferred.

A device 45 itself for automatic arrangement of an element on a further element, in particular the heat treatment material 2, according to the previous embodiments, may also constitute an independent invention.

Finally, as a matter of form, it should be noted that for ease of understanding of the structure, elements are partially not depicted to scale and/or are enlarged and/or are reduced in size.

List of reference signs

| | |
|---|---|
| 1 | continuous furnace |
| 2 | heat treatment material |
| 3 | quenching device |
| 4 | measuring system |
| 5 | measuring module |
| 6 | data module |
| 7 | support means |
| 8 | frame element |
| 9 | sample |
| 10 | width |
| 11 | data storage device |
| 12 | temperature sensor |
| 13 | support element |
| 14 | material edge |
| 15 | attachment lug |
| 16 | receptacle element |
| 17 | frame system elements |
| 18 | swivel axis |
| 19 | swivel axis mount |
| 20 | cotter pin |
| 21 | plane |
| 22 | height |
| 23 | protective element |
| 24 | clamping element |
| 25 | clamping jaw |
| 26 | eccentric lever |
| 27 | measuring tip |
| 28 | cover element |
| 29 | camera |
| 30 | light source |
| 31 | device |
| 32 | positioning rollers |
| 33 | adjustment device |
| 34 | acceleration device |
| 35 | engaging device |
| 36 | clamping clasp |
| 37 | electric motor |
| 38 | centering arm |
| 39 | distance |
| 40 | lever |
| 41 | stop |
| 42 | spring |
| 43 | sensorics |
| 44 | arrow direction |
| 45 | device |
| 46 | data logger |
| 47 | light barrier |
| 48 | switch |
| 49 | steel strip |
| 50 | magnet |

1. A measuring system (4) for determining the temperature of a, in particular belt-shaped, heat treatment material (2) in a continuous furnace (1), in particular in a floating belt installation, comprising a support means (7), a data processing and/or data storage device (11) and at least one temperature sensor (12), at least one receptacle for a sample (9) of the heat treatment material (2) being formed on the support means (7), wherein the support means (7) is at least partly formed by a frame system.

2. The measuring system (4) according to claim 1, wherein the frame system is configured as a tubular frame system.

3. The measuring system (4) according to claim 2, wherein the frame system has frame system elements (17) which can be telescopically slid into one another at least in certain areas.

4. The measuring system (4) according to claim 3, wherein the frame system elements (17), which can be telescopically slid into one another, are arranged on the support regions of the measuring system (4) on the heat treatment material (2).

5. The measuring system (4) according to claim 1, wherein the support means (7) is provided with swiveling frame system elements (17).

6. The measuring system (4) according to claim 5, wherein the swiveling frame system elements (17) are arranged in the end regions of the frame system.

7. The measuring system (4) according to claim 1, wherein the support means (7) has at least one inclined plane (21).

8. The measuring system (4) according to claim 1, wherein the data processing and/or data storage device (11) is arranged on the support means (7).

9. The measuring system (4) according to claim 8, wherein the inclined plane (21) is arranged in front of, in particular directly in front of, the data processing and/or data storage device (11).

10. The measuring system (4) according to claim 1, wherein the support means (7) has at least one attachment element for attaching the support means (7) to the heat treatment material (2).

11. The measuring system (4) according to claim 10, wherein the at least one attachment element or at least one attachment element is configured as a clamping element (24).

12. The measuring system (4) according to claim 11, wherein the clamping element (24) comprises an eccentric lever (26) and clamping jaws (25) and/or at least one inclined plane.

13. The measuring system (4) according to claim 1, wherein the data processing and/or data storage device (11) is arranged below a protective element (23) which is attached to the support means (7).

14. The measuring system (4) according to claim 1, wherein a camera (29) and optionally at least one light source (30) is/are arranged on the support means (7).

15. The measuring system (4) according to claim 14, wherein the camera (29) and/or the light source (30) is/are arranged on the data processing and/or data storage device (11), in particular integrated therein.

16. The measuring system (4) according to claim 1, wherein a measuring tip (27) of the sensor element is covered with a cover element (28) for watertight sealing of the area of the arrangement of the measuring tip (27) on the sample (9) of the heat treatment material (2).

17. The measuring system (4) according to claim 16, wherein the cover element (28) is formed by a cover foil or a solder.

18. The measuring system (4) according to claim 1, further comprising a device (45) for time synchronization and/or position determination of the measuring system (4) with a measuring system of the continuous furnace (1).

19. A continuous furnace (1), in particular floating belt installation, comprising a conveying device for conveying a, in particular belt-shaped, heat treatment material (2) through the continuous furnace (1) and a measuring system (4) for determining the temperature of the heat treatment material (2) in the continuous furnace (1), wherein the measuring system (4) for determining the temperature of the heat treatment material (2) in the continuous furnace (1) is formed according to claim 1.

20. The continuous furnace (1) according to claim 19, further comprising a device (31) for the automatic arrangement of the measuring system (4) on the heat treatment material (2).

21. The continuous furnace (1) according to claim 20, wherein the device (31) for automatic arrangement of the measuring system (4) has an acceleration device (34) for arranging the measuring system (4) on the running heat treatment material (2).

22. The continuous furnace (1) according to claim 20, wherein the device (31) for the automatic arrangement of the measuring system (4) is arranged directly upstream of a furnace inlet.

23. A method for determining the temperature of a, in particular belt-shaped, heat treatment material (2) in a continuous furnace (1), in particular in a floating belt installation, temperature data being measured with at least one temperature sensor (12), for which purpose the temperature sensor (12) is arranged on a sample (9) of the heat treatment material (2) which is placed on the heat treatment material (2), and remains on the heat treatment material (2) during the heat treatment, and transferring the temperature data to a data processing and/or data storage device (11), wherein the measuring system (4) according to claim 1 is used for measuring the temperature of the heat treatment material (2) and/or wherein the method is carried out in the continuous furnace (1) comprising a conveying device for conveying the heat treatment material (2) through the continuous furnace (1) and the measuring system (4).

24. The method according to claim 23, wherein the arrangement of the measuring system (4) on the heat treatment material (2) is carried out fully automatically with a device (31) for automatic arrangement of the measuring system (4) on the heat treatment material (2).
